(19) United States
(12) Patent Application Publication
(10) Pub. No.: US 2007/0214036 A1
(43) Pub. Date: Sep. 13, 2007

(54) Online product design

(76) Inventor: Gosakan Aravamudan, Bangalore (IN)

Correspondence Address: Ashok Tankha;Lipton, Weinberger & Husick, 36 Greenleigh Drive, Sewell, NJ, 08080, US

(21) Appl. No.: 11/698,578

(22) Filed: Jan. 25, 2007

(30) Foreign Application Priority Data
Mar. 8, 2006 (IN) 0405/CHE/2006

(51) Int. Cl. G06F 15/02; G06Q 10/00; G05B 19/418

(52) U.S. Cl. 705/9; 705/1; 705/8

(57) ABSTRACT

The method and system disclosed herein provide a means for developing product designs for a given product concept of a problem provider over a network. A problem provider inputs product design requirements of a product concept in a user interface. An environmental element module identifies environment elements for the product concept. A secondary perspective function module identifies secondary functions that can be added to the product concept from the perspective of the environmental elements. A components and applications selection module derives components for the product concept and secondary functions. A masking module masks the application of product concept. A vertical independent classification system (VICS) is provided that is a repository of functions with predetermined linkages, with solution provider classified under each function. Solution providers are selected from VICS for the masked product concept and secondary functions.

### BACKGROUND OF THE INVENTION

The present invention relates generally to knowledge management. More particularly, the invention relates to a computer implemented internet enabled system of product design.

Research is currently driven by the existing paradigm of a firm that is influenced by a predefined mission statement and the existing technology core competence of the firm. However, this existing paradigm limits the technology of the firm to its core domain expertise, places a constraint on the market outreach a firm and at times stifles innovation. True innovation sometimes needs to cross industry boundaries and focus on the customer's need rather than on a firm's internal technology capabilities and its static mission.

There is a need for an internet enabled new model of research and development that enables companies to design products outside their areas of core competence. The conventional mode of concept creation and product design revolves around a technology team with skills focused on a certain core technology sector. The management expert C. K. Prahalad's core competence elucidates this concept with core technology focus. However, core competence is a double-edged sword. It is sensible to develop solutions around a technical competency, however, rarely are all customer needs addressed by capabilities and solutions that evolve from within a certain technology domain. A solution for a customer typically demands skills from multiple industries, and possibly multiple technologies that cross multiple geographies or countries. Instead of “in house core competence”, companies need to focus on “cross industry competence” .

A firm's core technology obviously has multiple applications in multiple industry verticals. However, not all applications are obvious and apparent to the marketer or the technical team of a firm. There is a need for an internet enabled method and system that utilizes skills worldwide to identify novel cross industry applications of a given core technology or the existing product line of a company.

For example, consider a semiconductor manufacturer ABC Company who manufactures an Indium Gallium Arsenide (InGaAs) semiconductor chip used for light detection, and sells receivers containing the InGaAs chips to fiber-optic customers in the telecommunications industry. Assume that the demand for fiber-optic telecommunication equipment has fallen and ABC Company is unable to find customers for its packaged InGaAs chips in the telecommunications industry. The marketers and designers of ABC Company have a strong understanding of the application of the InGaAs chip in the telecommunications industry, but are unaware of the possible applications of the InGaAs chip in the defense, automotive or medical industries. In the defense industry, InGaAs chips are used as sensors in the tail wings of fighter aircrafts. In the automotive industry, InGaAs chips are used in the communication system of high end and lightweight car models. In the medical industry, InGaAs chips are used in optical sensing of high throughput screening applications. There are many additional applications for the InGaAs material in other industries, for example use of InGaAs chips in historic material conservation, ice detection in aircraft wings, camouflage detection in warfare and semiconductor wafer inspection. It is unrealistic to expect a marketer or a designer at ABC Company to have knowledge of applications of a particular component or system for all industries. In the ideal case, when a designer needs to identify and design a component for a particular application, the designer itemizes all the component options that the designer is aware of that meet the application requirements, and thereafter selects the most appropriate component. The co-pending patent application “Component and Application Finder” product and service itemizes and ranks all such component options. Identification of suitable components and systems to meet design criteria and satisfaction of unmet application needs in the product design process is a resource constraint and time consuming activity for the product design team. Also, alteration or modification of components or systems of a product in a certain industry allow the use of that application or product in another related or non-related industry to satisfy an entirely different application or need. Hence, designers, product managers and marketers continuously search for new components or systems for their application requirements, and also for multiple applications for their products.

In the conventional product design process, typically a scientist with domain expertise in a particular technology area designs a product addressing the unmet application need. However, the best component that meets the application might not necessarily reside in or evolve from the technology sector in which the scientist has expertise.

Consider the downstream end of a design process, for example where a medical device firm DEF Company in the area of high throughput screening is looking for a component to determine loss in the intensity of light after the passage of the light through a liquid medium. The firm is looking for the ideal component for such a light detection application. The designers of DEF Company are probably aware of one or two components that meet the light detection application such as the use of an Indium Gallium semiconductor chip. However, the ideal solution could be any of the following components: InGaAs chips, Indium Gallium (InGa) chips, or Indium Phosphide (InP) semiconductor chips.

There is an unmet market need for “problem masking” methodology to define the problem and for displaying the multiple solution sets for the research and development solution providers. There is a need for a “Problem masking” process that ensures that the actual problem or customer need and its potential novel solution options are not disclosed to the solution providers.

For each of the above potential solutions identified, technology skill sets that can deliver such solutions need to be identified. Typically, a solution provider who is focused on a certain industry vertical might be unaware that they have skillsets that can be utilized in multiple applications. Hence, its is a challenge to solicit a response from solution providers who are not aware of their own capabilities in non traditional industries. There is an unmet market need to classify such skill-sets and a method of identifying service providers who can provide those skill sets.

There have been efforts to develop an online worldwide network of service providers, and research and development service providers. However, the method of classification is focused on industry verticals. There is an unmet market need for a new vendor classification and selection system that classifies and identifies vendors in a manner that leverages their capabilities across the spectrum of technology domains, industries and applications.

### SUMMARY OF THE INVENTION

The novel model of research enabled by the method and system described herein comprises identifying cross industry applications, tapping on research and development capabilities worldwide, innovative problem solving, problem masking, online collaborative research, activities that are implemented in a platform that ensures that the problem definer's intellectual property is fully protected at every stage of the research and development process.

Consider an example of a customer requirement for a pen that can be also be used as a hand warming device in a cold winter day. If our client, for example a pen manufacturer encounters such a customer need, their research and development team may not necessarily have the internal resources to develop ideas, filter ideas, prototype the product and bring to production such a product which demands technology domain expertise in thermal devices and compact energy sources that can be integrated into a pen. In this case, the client needs to look externally for the design of such a product. The method and system disclosed herein would provide competent and affordable expertise in thermal devices and compact energy sources by tapping into an online community of technology domain, industry and research and development experts.

The intellectual property of a problem definer is protected from disclosure to a third party, using a problem masking procedure by the method and system described herein. Problem masking ensures that on the actual problem or customer need and its potential novel solution options are not disclosed to the R&D or other solution providers.

The method and system described herein provides a new vertical independent classification and selection system (VICS) that classifies and identifies vendors in a manner that completely leverages their capabilities. The method and system disclosed herein addresses and overcomes the scenario where a service provider might be unaware of their own knowledge base.

The method and system disclosed herein determines alternate product designs for a given product concept of a problem provider over a network. A problem provider is an individual or organization that desires a solution to their problem. Examples of problem providers include, product designers, research scientists etc. A problem provider inputs product design requirements of a product concept in a user interface. An environmental element module identifies environment elements for the product concept. A secondary perspective function module identifies secondary functions that can be added to the product concept from the perspective of the environmental elements. A components and applications selection module derives components for the product concept and secondary functions. A masking module masks the application of product concept. A solution provider is an individual or organization who are providing solutions to problems stated by the problem provider. Examples of solution providers include research organizations, freelance consultants, etc. A vertical independent classification system (VICS) is provided that is a repository of functions with predetermined linkages, with solution providers classified under each function. Solution providers are selected from VICS for the masked product concept and secondary functions.

### BRIEF DESCRIPTION OF DRAWINGS

The foregoing summary, as well as the following detailed description of the embodiments, is better understood when read in conjunction with the appended drawings. For the purpose of illustrating the invention, there is shown in the drawings exemplary constructions of the invention; however, the invention is not limited to the specific methods and instrumentalities disclosed.

FIG. 1 illustrates the various processes used in a computer implemented internet based system for developing or identifying alternate product designs for a given product concept of a problem provider.

FIG. 2 illustrates the computer implemented internet based system for developing or identifying alternate product designs for a given product concept of a problem provider.

FIG. 3 depicts an exemplary output of the secondary perspective functional module for a receiver.

FIG. 4 illustrates a method of masking the product design requirement.

### DETAILED DESCRIPTION OF DRAWINGS

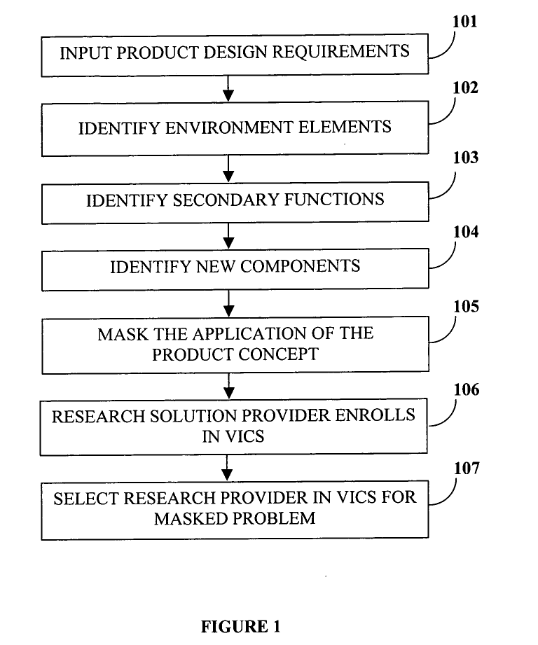

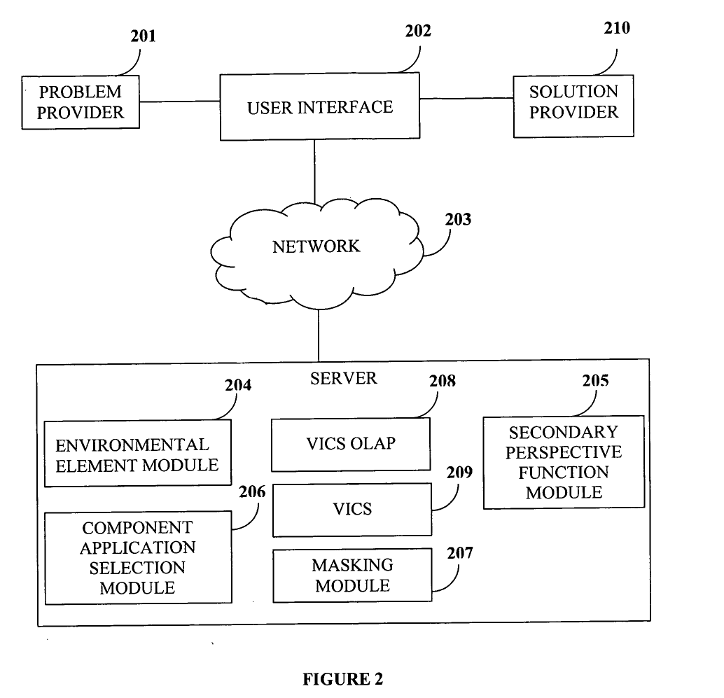

FIG. 1 illustrates the various processes used for determining alternate product designs for a given product concept of a problem provider 201. FIG. 2 illustrates the computer implemented internet based system for determining alternate product designs for a given product concept of a problem provider 201. A vertical independent classification system (VICS) 209 is provided for classification and selection of solution providers 210. The problem provider 201 is provided a user interface 202 connected via the internet to a server at which interface the problem provider enters the research or design services that he is seeking. The system can also be enabled on a private network instead of the internet. The problem provider 201 inputs 101 their design requirements in input fields in the user interface 202 in a predetermined format within the user interface 202. The format includes fields for filling in the definition of the customer need. The environmental element module 204 identifies the environmental elements 102 around the product to be designed. The secondary perspective function module 205 contains sets of elements and the corresponding functions 103 from the perspective of the elements. The component application selection module 206 identifies new components for the product concept and secondary functions 104. The masking module 207 masks the problem using natural language processing 105. The masked problem is then transmitted to a selected set of enrolled 106 research vendors. The selection of the vendors 107 is performed using a VICS online analytical processing (OLAP) 208 tool that maps the input fields to classification parameters in the VICS 209. Research providers enroll themselves in the VICS 209 and respond to the design requests.

The environment elements comprise the proximate physical environment of the fundamental product and people who interact with the product. The user interface 202 is used for inputting the basic function of the product that the problem provider 201 wishes to design. The problem provider 201 can either input the elements of the environment, or the environment element module 204 automatically generates the environmental elements when the problem provider 201 inputs their product information. For example, in the aforementioned example of the pen, the elements of the use environment include the hand, paper, clothing, briefcase, etc. When the problem provider 201 inputs “pen”, the environmental element module 204 generates the words such as: hand, paper, clothing, briefcase, etc. The creation and enablement of the environmental element module 204 is described in the co-pending patent applications, U.S. patent application titled “Component and Application Finder”, and Indian patent application no. 1272/CHE/2005, titled “Method and System for Product Design”. A perspective element reflects the ideal and perception of the product concept and generates the secondary function 103. The components application selection module 206 is used to derive component substitutes for the product concept and secondary functions. The component application selection module 206 comprises a search engine that searches for components for a given function in a database of components and functions. The creation and enablement of the component application selection module 206 is described in detail in the co-pending patent applications, U.S. patent application titled “Component and Application Finder”, and Indian patent application no. 1272/CHE/2005, titled “Method and System for Product Design”.

For example, the environmental element “hand” would perceive the pen to be a device to be held and moved while writing. If the user were living in a very cold environment, the pen could be ideally perceived to be a hand warming device. If the user needed a light source in dark, the pen could be ideally perceived to include a light source. The secondary perspective function module 205 is used for inputting a perspective functionality of the product concept, wherein the perspective functionality is the functionality that is perceived by the respective element in the context of said respective element. For example, in the case of the pen, the primary perspective function of the pen is “a means of creating an impression on paper” or “a means of writing”. A secondary perspective functional module 205 generates a plurality of secondary perspective functions perceived for each environmental element.

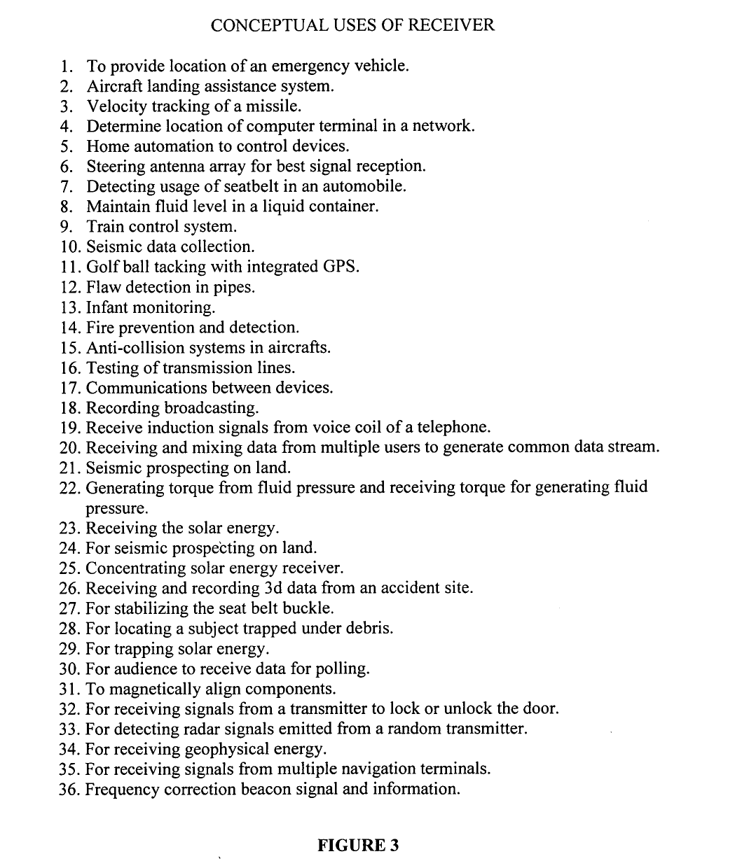

Consider another example, wherein a problem provider 201 desires to find novel applications for their GPS receiver using the secondary perspective functional module 205. When the problem provider 201 inputs “global positioning system receiver”, the secondary perspective functional module 205 outputs the multiple other potential functional uses of the “global positioning system receiver”. FIG. 3 depicts an exemplary output of the secondary perspective functional module for a receiver. It is to be noted that not all such solutions generated by looking for the uses of the abstracted term “receiver” may be viable. The problem provider 201 chooses a subset of functions listed by the secondary perspective functional module. The functionality is a utility, application or activity.

The problem provider 201 may optionally set a specification target for the product. The specification target of the product is a set of product parameters with target values. The solution provider 210 would then be required to provide a conceptual product solution with the product components identified, as well as a preliminary filled in product specification sheet. The definition of the product is the list of functional attributes of the product.

The environmental element module 204, secondary perspective function module 205, VICS 209, VICS OLAP 208 and masking module 207 automate the environmental element identification, determination of perspective functions, classification of vendors, selection of vendors and problem masking. Each one of these automated processes can also be manually performed through assistance from the intermediary who manages the system disclosed herein. In the manual process, the problem provider 201, intermediary and vendor can work together using online collaboration tools. These tools are available off the shelf, and can be integrated into the method and system disclosed herein. These tools are established prior art, and hence they are not detailed in the method and system disclosed herein. For example, the problem provider 201 can collaboratively work real time via an internet online collaboration tool to choose new functions and component sets, using assistance from the intermediary in accessing the component application selection module.

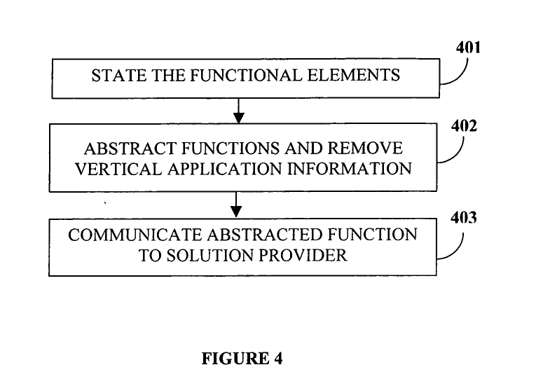

FIG. 4 illustrates a method of masking the problem. The product and its potential solutions are broken down into functional components 401. The required functionality, without any information on the end application of the components 402, 403 is then presented to the solution provider 210 for problem solving. For example, if the problem provider 201 wishes to integrate the hand warming function in a pen, the problem is masked as follows. The product design problem is broken down into the following two separate masked problems; to identify a very small form factor component A that is a power source, and to identify a very small factor component B that generates heat by being powered by component A. The component A problem definition, i.e., the requirement of a very small factor power source is sent to Vendor A, and component B problem definition, i.e., the requirement of a very small factor heating element is sent to Vendor B. Neither Vendor A nor Vendor B now know the final application of their solutions, i.e., a pen used as a hand warmer.

The service providers are classified along those parameters based on which the solution design requirements are defined. The classification is based on three independent dimensions. The first dimension is the industry vertical independent technology core competence, herein referred to as vertical independent competence selection (VICS) 209. The second dimension is the environmental impact familiarity and the third dimension is “need familiarity”. The classification of VICS 209 has no inherent hierarchy. Any competence is an amalgamation of one or more nodes in the VICS 209 universe. Each node in the VICS 209 universe can potentially have a relationship with every other node in the VICS 209 universe.

Optionally, solution providers 210 classified based on VICS 209 are rated on the intellectual property parameter. For a highly ranked service provider, the means of performing functions is typically claimed in the preamble of independent claim of the service provider in a patent of the solution provider 210, wherein the solution provider 210 is an assignee or author of the patent document. The solution provider 210 is classified under said means of performing functions.

There are two aspects to the success of a classification system. The classification system can be abstracted to be a universe of nodes and their linkages. Firstly, it must be viable to create the nodes and, it must be also be viable to draw linkages between the nodes the relationship between the nodes. Secondly, when an article or person needs to be classified in such a classification system, the system should be able to accept inputs in known terms of the art and thereafter automatically classify the person or article within the classification system using the known terms of the art. The method and system disclosed herein addresses the scenario where a service provider is unaware of their own knowledge base. For example, an acoustic wave designer at the Bose, Inc. audio firm might be unaware that their acoustic modeling skills can be transferred and used extensively in modeling wave patterns in oceanography. When the acoustic wave designer Joe Smith of Bose, Inc. enrolls into VICS, they input their title as “Design Engineer” and area of industry expertise as “Audio system design”. The VICS OLAP 208 engine classifies Joe Smith in VICS 209 as an expert in multiple domain areas such as “wave modeling”, “acoustic modeling”, “audio system design”, etc. If a problem provider 201, say John Roe, were seeking advice on how he could use a small water body to conduct wave modeling, the VICS 209 OLAP 208 will pull up John Smith as a potential research solution provider to advice on how a small container can be used for wave modeling.

A solution provider 210 needs to enroll into VICS 209. The input parameters are standard and comprise job title, products expertise and industry vertical expertise. When the acoustic wave designer Joe Smith of Bose, Inc. enrolls into VICS 209, they input their title as “Design Engineer” and product expertise as “Audio system design” and industry expertise as “audio industry”. A transformation function transforms these standard input parameters into VICS 209 classification parameters. The transformation function first determines if the job title represents a technical skill-set or a customer focused skill-set. Job titles such as marketing manager, product manager, application's engineer are customer focused skillsets. Job titles such as design engineer, project engineer, research scientist, etc., are technical titles. A database of restored titles and their commercial and technical orientations are used to determine the commercial or technical type of skill set a job title signifies. If the skill-set is technical, the transformation function breaks down the product in which the vendor is an expert into its components and the components integration synergies, and classifies the vendor as a design expert in the product and the component's integration synergies. If the skill-set is customer focused, the transformation function determines the customer of the product in which the vendor is an expert and classifies the vendor as a design expert in the product and the component's integration synergies. The following example illustrates the use of the expertise of a Marketing Manager of Mark Barney of Bose, Inc. Mark enrolls into VICS 209. When a problem provider 201 states his or her problem as: “integrate audio capability into a pen”, the VICS 209 OLAP 208 engine identifies Mark Barney as a vendor who can provide expertise in understanding a customer's audio experience and requirements.

The intellectual property of both the problem provider 201 and the solution provider 210 is protected in the method and system disclosed herein. The product attributes are defined by the problem provider 201. Novel sets of components are identified. The claim is assigned to the problem provider 201. The step of filing a claim of the set of said components that constitute the product to a government recognized agent, comprises the step of electronically depositing the claim at said agency through the internet design space maintained by the intermediary. For example, consider the case of a problem provider 201 who uses the secondary function perspective module and identifies that a heating element can be introduced into a pen to convert it into a hand warming device for application in cold climates. In this example, the following claim of the set of components that constitute the product will be electronically transmitted to a government recognized agent, through the internet design space maintained by the intermediary: “A multifunction pen with a heating element and a compact power source for said heating element”. The intermediary selects one or more solution providers 210 for designing the product. The solution providers 210 and the problem provider 201 sign a waterfall business agreement with the intermediary. The waterfall business agreement comprises assigning the intellectual property rights of the product design problem prior to masking to the problem provider 201. The intellectual property rights of the recommended product solution by a research solution provider 210 are assigned to the solution provider 210, provided the solution provider determines all the components of the product solution. A part or the entire intellectual property rights of the specification of the product solution is assigned to the problem provider 201 if the problem provider 201 buys the product solution from the solution provider 210 at the quoted price of the research solution provider. An online collaborative tool is provided for collaborative problem solving by multiple research solution service providers.

The foregoing examples have been provided merely for the purpose of explanation and are in no way to be construed as limiting of the method and system disclosed herein. While the invention has been described with reference to various embodiments, it is understood that the words which have been used herein are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A computer implemented system for developing product designs for a product concept of a problem provider by a plurality of solution providers, over a network in communication with a server, said system comprising:
a user interface for inputting product design requirements of the product concept by said problem provider;
an environmental element module for identifying the environment elements for said product concept;
a secondary perspective function module for identifying secondary functions that can be added to the product concept from the perspective of said environmental elements;
a components and applications selection module that is used to derive components for said novel product concepts and applications derived from the vertical independent classification system;
a masking module for masking the application of product concept and said secondary functions; and
a vertical independent classification system that is a repository of functions with predetermined linkages, with solution provider classified under each function, wherein the secondary functions and product concepts are identified in said vertical independent classification system, whereby a plurality of solution provider are chosen for the design of a novel product for the product concept and for performing secondary functions.

2. The method of claim 1, wherein the network is the internet or a private network, or a combination of the internet and a private network.

3. The method of claim 1, wherein said server hosts the environmental element module, secondary perspective function module, masking module, vertical independent classification system and the components and application selection module.

4. The system of claim 1, wherein said environmental elements identified from said environmental element module environment comprises the proximate physical environment elements of the product concept and the types of human users of the product concept.

5. The system of claim 1, wherein said component and application selection module comprises a search engine that searches for components for a given function in a database of components and functions.

6. A computer implemented network based method for determining alternate product designs for a given product concept of a problem provider over a network with a server, comprising:
inputting product design requirements for a product concept by said problem provider;
identifying environment elements for said product concept;
identifying secondary functions that can be added to the product concept from the perspective of said environmental elements;
providing a components and applications selection module that is used to derive components for the product concept and said secondary functions;
masking the application of the product concept and said secondary functions; and
providing a vertical independent classification system that is a repository of functions with predetermined linkages, with solution provider classified under each function, wherein the secondary functions and product concepts are identified in said vertical independent classification system, whereby a plurality of solution provider are chosen for the design of a novel product for the product concept and for performing secondary functions.

7. The method of claim 6, wherein the problem provider and the solution provider collaboratively work real time via the internet to choose environmental elements and component sets.

8. The method of claim 6, wherein said functionality is a utility, application or activity.

9. A method of classifying service providers, comprising the steps of:
identifying means of performing functions claimed in the preamble of independent claim of the service provider in a patent of the service provider, wherein the service provider is an assignee or author of the patent document;
creating an hierarchical information database of means of performing functions; and
classifying the service provider under said means for performing functions.
